(19) United States
(12) Patent Application Publication
(10) Pub. No.: US 2011/0130264 A1
(43) Pub. Date: Jun. 2, 2011

(54) NEGATIVE-CTE GLASS-CERAMICS FREE OF MICROCRACKS

(76) Inventor: George Halsey Beall, Big Flats, NY (US)

(21) Appl. No.: 12/627,290

(22) Filed: Nov. 30, 2009

(51) Int. Cl. C03C 10/14

(52) U.S. Cl. 501/4

(57) ABSTRACT

A glass-ceramic composition, an article, and methods of making and using the composition and article as defined herein. The glass-ceramic compositions and articles have negative-CTE and are substantially free of microcracks.

The entire disclosure of any publication, patent, or patent document mentioned herein is incorporated by reference.

### FIELD

The disclosure relates generally to glass-ceramic compositions and methods of making the compositions.

### SUMMARY

The disclosure provides glass-ceramic compositions, articles, and methods of making the compositions and articles. In embodiments, the disclosed glass-ceramic compositions and articles therefrom can have negative-CTE and can be free of microcracks.

### BRIEF DESCRIPTION OF THE DRAWING(S)

In embodiments of the disclosure:

FIG. 1 shows a thermal expansion curve of an exemplary translucent glass-ceramic.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments for the claimed invention.

### DEFINITIONS

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example: through typical measuring and handling procedures used for making compounds, compositions, composites, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. The claims appended hereto include equivalents of these “about” quantities.

“Consisting essentially of” in embodiments refers, for example, to a membrane polymer composition, to a method of making or using the membrane polymer, formulation, or composition, and articles, devices, or any apparatus of the disclosure, and can include the components or steps listed in the claim, plus other components or steps that do not materially affect the basic and novel properties of the compositions, articles, apparatus, or methods of making and use of the disclosure, such as particular reactants, particular additives or ingredients, a particular agents, a particular surface modifier or condition, or like structure, material, or process variable selected. Items that may materially affect the basic properties of the components or steps of the disclosure or that may impart undesirable characteristics to aspects of the disclosure include, for example, a resulting glass-ceramic having a non-negative CTE at 25 to about 800° C.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, and like abbreviations).

Specific and preferred values disclosed for components, ingredients, additives, reactants, reagents, polymers, oligomers, monomers, times, temperatures, and like aspects, and ranges thereof, are for illustration only; they do not exclude other defined values or other values within defined ranges. The compositions and methods of the disclosure include those having any value or any combination of the values, specific values, more specific values, and preferred values described herein.

Materials with a negative coefficient of thermal expansion (CTE) are very rare, but they can be valuable in lowering the CTE of various composite materials, including for example, glass-ceramic flits and multiphase ceramics. One such material is well-known: β-eucryptite, an hexagonal LiAlSiO₄. In polycrystalline ceramic or glass-ceramic form, it derives its negative CTE from high directional anisotropy in the CTE along crystallographic directions, one of which, the c-axis is strongly negative, while the other directions (a-axes) are positive. Although the average CTE is close to zero, the strong anisotropy causes microcracks in ceramics or glass-ceramics composed largely of this crystal phase as long as the crystals are large enough to produce sufficient intergranular stress to allow fracture along grain boundaries.

Glass-ceramics composed of β-quartz solid solutions are well-known in the glass-ceramic literature (see for example, Beall, G. H., U.S. Pat. No. 3,252,811 ('811 patent); Beall, G. H., et al., Crystallization and Chemical Strengthening of Stuffed β-Quartz Glass-Ceramics, J. Am. Ceram. Soc., 50 (4), pp. 99-113 (1967); Strnad, Z., Glass-Ceramic Materials, Elsevier, 1986; Holand, W., et al., Glass-Ceramic Technology, Am. Ceram. Soc., 2002). Two glass-ceramics have been noted (see Table II in Beall, G., et al, 1967, supra) that contain β-quartz solid solutions composed of the same oxides of the present disclosure. However, in these noted glass-ceramics the CTEs, while slightly negative in the 25-300° C. range, do not have the desired magnitude of CTE negativity provided by compositions of the present disclosure, nor do the presently disclosed glass-ceramics fall in the compositional range of the noted compositions. The noted compositions being above about 65 wt. % SiO₂ compared to less than 60 wt. % in the presently disclosed compositions. Moreover, there were no perceived applications for these materials nor advantages over related glass-ceramics of near-zero CTE at that time.

All of the presently disclosed compositions are less than 60 wt. % (see Table 1), while at least 60 wt. % is required in '811 patent. However, composition C3 is very close, at 59.9 wt. %. In the presently disclosed compositions, ZrO₂ is, for example, about 1.3 wt. %, and outside the 2.0-15 wt. % range of the '811 patent. Moreover, the compositions generally described in the '811 patent mentions only transparent glass-ceramics. The presently disclosed materials are translucent or opaque. One composition in Table II of the '811 patent does, however, exhibit a small negative CTE of −7×10⁻⁷/° C., but this was measured over 25 to 300° C. At temperatures of 25 to 800° C. specified in the present disclosure, the CTE value of the composition of the '811 patent is expected to be near zero or even positive.

In practical applications, crystals larger than about ten micrometers are sufficient to cause a high density of microcracks, providing the crystal phase exhibits anisotropic thermal expansion behavior (e.g., negative along one axis and positive along another). The effect of the microcracks is to bias the bulk CTE in favor of the negative-CTE direction and produce a material of bulk negative CTE. There are serious difficulties, however, associated with using microcracked negative-CTE materials like β-eucryptite to lower the bulk CTE of fillers for frits, cements, or other powder-formed ceramics. When ceramics or glass-ceramics composed primarily of β-eucryptite or other low-CTE microcracked materials are ground into a powder for suitable batch addition, the material can break up along the microcracks and the phenomenon required to create the negative CTE is severely compromised or completely destroyed. It is usually useful to fine-grind batch materials for slurry-formed ceramics and frit-coatings for desired rheological behavior, and therefore microcrack-based low-CTE materials are generally not practical as CTE-lowering additives in composite materials.

During research on glass-ceramics, compositions having negative-CTE behavior were discovered. Interestingly and surprisingly, the discovered compositions were free of microcracks. The new disclosed compositions can be formed by at least two different routes. In embodiments, the crystals of the glass-ceramics can be, for example, internally nucleated from the parent glass with the aid of a nucleating agent melted into the glass. Alternatively, in embodiments, the crystals of the glass-ceramics can be, for example, externally nucleated from the surfaces of finely powdered glass. The crystalline phase is a distinctive solid solution with a β-quartz structure derived from certain glasses in the SiO₂—Al₂O₃—ZnO—Li₂O system.

In embodiments, the disclosed compositions can be prepared, for example, from powdered materials that are ground from a previously formed glass-ceramic article, or made from a fine glass frit that is subsequently sintered and crystallized. The resulting powdered materials can be used as fillers or sintering aids to reduce the CTE of articles or structural components of, for example, artificial skins, plugging materials, or like components of diesel filters. The resulting powdered materials can also be used, for example, as skins for catalytic converter substrates to match the low CTEs of these products.

Certain artificial skins for cordierite or aluminum titanate monoliths in use for either catalytic converters or diesel filters are beset by several problems. They contain organic binders which burn-off during firing of coatings and catalysts. The binder burn-off can weaken the skin to the point that it may be prone to chipping. Moreover, artificial skins can have higher CTEs than the substrate and therefore can shrink more on cooling, leading to tension cracks and weakening of the articles. A component material with a negative CTE can eliminate the tension on the skin by allowing a close match of the CTE of skin and body, or alternatively producing some modest surface compression to increase the strength of the honeycomb article. Also, the capacity of this component material as a sintering aid would increase the coherence and strength of the skin during subsequent heating as catalytic coatings are applied. For current plug formulations on diesel filters, there are also issues involving the development of stress at the boundary of the plug and cell wall, again due to the large mismatch in CTE. This can be eliminated by lowering the CTE of the plug to match that of the cellular filter. The disclosed negative CTE materials can provide a component powder which accomplishes such a CTE match. For current plug formulations on diesel filters, there can also be issues involving the development of stress at the boundary of the plug and cell wall, again due to the large mismatch in CTE. This can be eliminated by lowering the CTE of the plug to match that of the cellular filter. The disclosed negative CTE material provides a component powder which achieves such a CTE match.

In embodiments of the disclosure, the issue of CTE mismatch between structural components in a ceramic can be overcome by, for example, providing glass-ceramic or like compositions having negative CTE values and which compositions are free of microcracks.

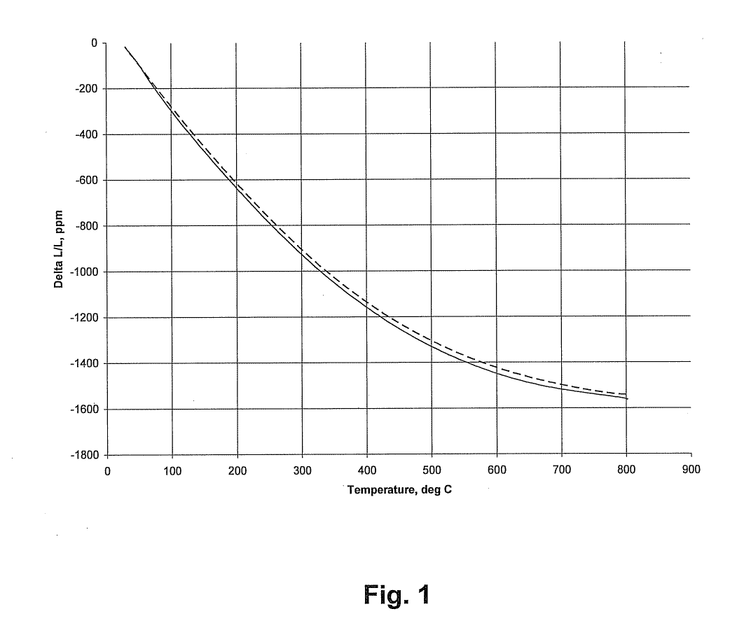

The disclosure relates generally to glass-ceramics formed from certain glasses in the basic SiO₂—Al₂O₃—ZnO—Li₂O system. Internal nucleation via the addition of precipitating nucleating agents, such as ZrO₂ and TiO₂, or surface nucleation from powdered glass can be used. A simple heat treatment achieves the desired crystal, which is a solid solution of the O-quartz structure, where Si⁴⁺ is partially replaced by Al³⁺ and a mixture of Zn²⁺ and Li⁺ “stuff” or fill some of the holes in the structure to preserve electrical neutrality. The resulting glass-ceramic has a negative-CTE and is thermally at temperatures of 800° C. to 1,000° C. for extended periods, such as many hours. The range of negative CTEs, measured at from 25 to 800° C., can be, for example, from −10 to −30×10⁻⁷/° C. A typical thermal expansion curve for a negative-CTE glass-ceramic material of the disclosure (Composition C1, Table 1) is shown in FIG. 1.

In embodiments, the disclosure provides a glass-ceramic composition, on a weight percent oxide basis, comprising:

40 to 60 wt % SiO₂,

20 to 35 wt % Al₂O₃,

5 to 20 wt % ZnO,

1.5 to 5 wt % Li₂O,

the composition includes a solid solution of β-quartz crystal phase of at least 50 wt %, and the molar ratio of (Li₂O+ZnO)/Al₂O₃ being less than 1.2, and having a negative CTE_{25 to 800° C.}. The negative CTE_{25 to 800° C.} refers the linear coefficient of thermal expansion from 25 to 800° C.

The disclosed glass-ceramic composition is translucent or opaque, and is free of microcracks. The negative CTE_{25 to 800° C.} can be, for example, of from about −10/° C. to about −30×10⁻⁷/° C. In embodiments, the composition can further include, for example, from about 0.1 to about 5 wt % P₂O₅, from about 0.1 to about 3 wt % B₂O₃, or a combination thereof. In embodiments, the P₂O₅ can be, for example, present in an amount of from about 1 to about 5 wt %, and the B₂O₃ can be, for example, present in an amount of from about 1 to about 3 wt %, or a combination thereof. In embodiments, the disclosed composition can further include, for example, ZrO₂ in an amount of about 0.1 to about 7 wt %. The ZrO₂ can be present, for example, in an amount of about 2 to about 7 wt %. In embodiments, an excellent nucleating agent for a glass is ZrO₂ in an amount of about 2 to 7 wt % ZrO₂.

In embodiments, the disclosed composition can further include, for example, TiO₂ present in an amount of about 0.1 to about 5 wt %. In embodiments, the disclosed composition can further include a combination of TiO₂ and ZrO₂, for example, TiO₂ in an amount of about 0.1 to about 5 wt % and ZrO₂ in an amount of about 2 to about 7 wt %. In embodiments, the TiO₂ and ZrO₂ can be present in a combined total weight percent of at least about 4 wt %. In embodiments, the composition negative CTE composition can be, for example, of the formula (Li₂, Zn)O.Al₂O₃.nSiO₂ where 8>n>2. In embodiments, MgO can replace, on a molar basis, the ZnO in the stuffed β-quartz structure. However, too much ZnO can raise the CTE of the composition. Thus, the MgO can be present in the stuffed β-quartz composition, for example, at no more than about 2 wt. %, and the mole ratio of (Li₂O+ZnO+MgO) to Al₂O₃ can be, for example, from about 1.3 and about 0.8, i.e., (Li₂O+ZnO+MgO):Al₂O₃=0.8 to 1.3.

In embodiments, MgO can be in admixture with the ZnO in the stuffed β-quartz structure. The combination of ZnO and MgO being greater than or equal to about 5.5 wt. % of the composition.

In embodiments, the disclosure provides a method for preparing a negative-CTE composition, comprising:

heating a glass with suitable nucleating agent to precipitate crystals of a glass-ceramic, the crystalline phase of the composition is a solid solution having a β-quartz structure of the formula nSiO₂—Al₂O₃—ZnO—Li₂O, where 8>n>2, and the composition can be entirely or substantially free of microcracks.

The nucleating agent can be, for example, at least one of ZrO₂, TiO₂, or combinations thereof, and heating the glass with suitable nucleating agent can be accomplished, for example: internally from the parent glass; externally nucleated from the surfaces of finely powdered glass; or a combination thereof. The heating can be accomplished, for example at about 750 to about 1,000° C. to provide a high degree of crystallization.

In embodiments, the disclosure provides a method for preparing a negative-CTE glass-ceramic composition, including, for example:

heat-treating a glass composition, on a weight percent oxide basis, comprising:
40 to 60 wt % SiO₂,
20 to 35 wt % Al₂O₃,
5 to 20 wt % ZnO,
1.5 to 5 wt % Li₂O; and

crystallizing the glass.

The heat-treating can be accomplished by, for example, 300° C./hr to 750° C., held for 2 hours, 300° C./hr to 850° C., held for 4 hours, and then cooled at furnace rate. The method can further include, for example, grinding the heat-treated composition into a powder prior to crystallizing.

In embodiments, the disclosure provides a method for preparing a negative-CTE glass-ceramic composition, including, for example:

combining a powdered glass-ceramic composition comprising:
40 to 60 wt % SiO₂,
20 to 35 wt % Al₂O₃,
5 to 20 wt % ZnO,
1.5 to 5 wt % Li₂O,
   and a batch composition to reduce the CTE of the resulting articles or structural components prepared therefrom. The articles or structural components can be, for example, a filler, a sintering aid, an artificial skin, a plugging material, or a combination thereof. The CTE of the resulting articles or structural component remains negative over the range of 25° C. to 800° C.

Features of using negative-CTE materials in glass-ceramics, or like articles are discussed below.

The disclosed glass-ceramic compositions can be conveniently prepared, for example, from powder ground from an original glass and then sintered and crystallized in a simple heat treatment. Alternatively, the disclosed glass-ceramic compositions can be prepared directly by heat-treating and crystallizing a previously formed glass article. In the latter approach, it is desirable to include certain oxides, typically ZrO₂, TiO₂, or a mixture of both, in the parent glass to provide nucleation, and in this instance the glass-ceramic article is ground into a powder after the heat treatment. Typical applications for these powder materials include, for example, fillers or sintering aids in artificial skin and plug formulations that can approximate or match low CTEs of diesel filter articles and catalytic converter substrates.

In embodiments, the disclosure provides negative-CTE glass-ceramics which are composed primarily of Zn—Li stuffed β-quartz solid solution crystals. The negative thermal expansion characteristics are displayed in FIG. 1 for an exemplary glass-ceramic of the disclosure. The average CTE over 25 to 800° C. can be, for example, −20×10⁻⁷/° C. From 25° C. to 300° C., the CTE is approximately −33×10⁻⁷/° C. The compositional components and range for the disclosed glass-ceramics in weight percent (wt %) can be, for example: SiO₂ 40 to 60, Al₂O₃ 20 to 35, ZnO 5 to 20, Li₂O 1.5 to 5, ZrO₂ 0 to 7, and TiO₂ 0 to 5. The molar ratio of (Li₂O+ZnO)/Al₂O₃ can be, for example, less than 1.2. Certain oxides, such as P₂O₅ and B₂O₃ can optionally be added in amounts of up to 5 and 3 weight percent, respectively. If it is desired to make a glass article and then heat and crystallize it by thermal treatment via internal nucleation, the ZrO₂, TiO₂, or a mixture thereof, should be included. If it is desired to sinter a powdered glass and crystallize it, then the P₂O₅ and B₂O₃ oxides can be added for improved sintering. In either situation, the original glass, whether a powder or an article, can be heated at about 750 to about 1,000° C. to allow a high degree of crystallization to the stuffed β-quartz solid solution of general composition SiO₂—Zn(AlO₂)—LiAlO₂. For internally nucleated glass-ceramics, some nanocrystals of tetragonal ZrO₂ or ZrTiO₄ will be present. Typically, powders of these glass-ceramics or their parent glasses can be obtained and mixed with suitable ceramic formulations, for example, as a slurry, that can be coated on a ceramic honeycomb monolith or squeezed into cells of such a monolith to selectively plug the cells upon heat treatment. Several representative examples (C1 to C9) of the composition of the parent glasses and glass-ceramics of the disclosure are listed in Table 1 in weight percents as batched.

TABLE 1
Exemplary compositions of the disclosed parent glasses and glass-
ceramics.

| Oxide | C1 | C2 | C3 | C4 | C5 | C6 | C7 | C8 | C9 |
|---|---|---|---|---|---|---|---|---|---|
| SiO₂ | 50.5 | 55.7 | 59.9 | 52.5 | 54.9 | 56.9 | 50.0 | 47.5 | 48.1 |
| Al₂O₃ | 28.4 | 28.3 | 25.5 | 29.5 | 27.9 | 25.3 | 30.5 | 31.6 | 29.3 |
| ZnO | 14.4 | 7.6 | 8.1 | 15.0 | 11.1 | 9.6 | 15.0 | 15.0 | 14.4 |
| Li₂O | 2.9 | 4.1 | 3.0 | 3.0 | 2.7 | 2.9 | 3.0 | 3.0 | 2.9 |
| ZrO₂ | 3.8 | 1.6 | 1.3 | 0.0 | 3.4 | 2.9 | 0.0 | 0.0 | 3.8 |
| TiO₂ | 0.0 | 2.7 | 2.2 | 0.0 | 0.0 | 1.4 | 0.0 | 0.0 | 0.0 |
| P₂O₅ | 0.0 | 0.0 | 0.0 | 0.0 | 0.0 | 0.0 | 1.5 | 2.9 | 1.5 |

Referring to the FIGURE, FIG. 1 shows a thermal expansion curve of an exemplary translucent glass-ceramic referred to as Composition 1 (C1) in the Table 1. The lack of hysteresis between the heating curve (solid line, left-to-right) and the cooling curve (dashed line, right-to-left) is notable, and is indicative of a non-microcracked material.

### EXAMPLES

The following examples serve to more fully describe the manner of using the above-described disclosure, as well as to set forth the best modes contemplated for carrying out various aspects of the disclosure. It is understood that these examples do not limit the scope of this disclosure, but rather are presented for illustrative purposes. The working examples further describe how to make and use the articles and methods of the disclosure.

The starting materials are commercially available such as from Sigma-Aldrich and like suppliers; can be, for example, prepared by known methods; can be isolated from a complex matrix by known methods, and like sources and methods. All commercially available chemicals were used as received.

### Example 1

### Actual

Internal nucleation method for preparing a negative-CTE composition This example (Composition C1, Table 1) exemplifies the internal nucleation approach. A batch of 525 g of QP Mintec sand, 295 g of low-soda Alcoa alumina, 75 g of lithium carbonate, 150 g of zinc oxide, and 40 g of zirconium oxide (S-grade) was ball-milled for 60 minutes. The resulting powder mixture was placed in a 650 cc platinum crucible and placed in a Globar (SiC resistance) furnace and melted for 16 hours at 1,625° C. The resulting liquid glass was poured into a 4″×8″ patty (about ¾″ thick), and allowed to cool until hardened. The glass patty was then placed into an annealing furnace at 725° C. and held overnight and then further cooled and removed from the furnace. The resulting transparent glass slab was then placed in a platinum-wound electric furnace and heat-treated according to: 300° C./hr. to 750° C., held two hours, 300° C./hr. to 850° C., held 4 hours, and cooled at furnace rate. The resulting glass-ceramic patty was then cut into bars of appropriate shape for thermal expansion measurements, revealing the negative coefficient of thermal expansion (see FIG. 1). A small portion of the glass-ceramic powdered and x-ray diffraction measurements confirmed the presence of stuffed β-quartz as the major phase. The remainder of the glass-ceramic patty could then be ground up and used in a ceramic mixture to lower the thermal expansion of a ceramic body. It should be noted that a glass-ceramic article of any shape compatible with known glass-forming techniques (e.g., pressing, rolling, etc.) could be made using this technique, including more complex articles having a negative thermal expansion.

### Example 2

### Prophetic

Surface nucleation method for preparing a negative-CTE composition. This example (Composition C7, Table 1) exemplifies the surface nucleation approach. A glass batch of 500 g of Berkeley Silcosil 7 sand, 301 g Alcoa low-soda alumina, 19 g of aluminum metaphosphate, 150 g of zinc oxide, and 75 g of lithium carbonate is mixed, melted and cast into a patty as in Example 1. After annealing the glass as in Example 1, the glass patty is ground up and is mixed with the ceramic powder to be sintered in the range from 900° C. to 1,000° C. During sintering the glass powder crystallizes to the negative-CTE stuffed β-quartz phase and reduces the CTE of the ceramic. Alternatively, the glass powder can be crystallized in situ between 900° C. and 1,000° C., then reground, and used as an additive in a ceramic batch to lower its CTE. In this instance, there is no sintering aid provided by the additive.

### Comparative Example 3

A comparative result for a microcracked negative-CTE glass-ceramic is disclosed, for example, in U.S. Pat. Nos. 6,362,118 to G. Beall, et al., entitled “Method of Making Stabilized Negative Thermal Expansion Optical Waveguide Substrate and Glass Ceramic Substrate,”; 7,254,297, to G. Beall, et al., entitled “Athermal optical device employing negative expansion substrate”; or 6,490,394, to G. Beall, et al., entitled “A thermal optical device.”

The disclosure has been described with reference to various specific embodiments and techniques. However, it should be understood that many variations and modifications are possible while remaining within the spirit and scope of the disclosure.

What is claimed is:

1. A glass-ceramic composition, on a weight percent oxide basis, comprising:
40 to 60 wt % SiO₂,
20 to 35 wt % Al₂O₃,
5 to 20 wt % ZnO,
1.5 to 5 wt % Li₂O,
the composition includes a solid solution of β-quartz crystal phase of at least 50 wt %, the molar ratio of (Li₂O+ZnO)/Al₂O₃ being less than 1.2, and having a negative CTE_{25 to 800° C.}.

2. The composition of claim 1 wherein the glass-ceramic is free of microcracks.

3. The composition of claim 1 wherein the glass-ceramic is translucent, or opaque.

4. The composition of claim 1 wherein the negative CTE_{25 to 800° C.} is of from about −10/° C. to about −30×10⁻⁷/° C.

5. The composition of claim 1 further comprising 0.1 to 5 wt % P₂O₅, 0.1 to 3 wt % B₂O₃, or a combination thereof.

6. The composition of claim 5 wherein P₂O₅ is present in an amount of from about 1 to 5 wt %, and the B₂O₃ is present in an amount of from about 1 to 3 wt %, or a combination thereof.

7. The composition of claim 1 further comprising ZrO₂ present in an amount of about 0.1 to about 7 wt %.

8. The composition of claim 7 wherein the ZrO₂ is present in an amount of about 2 to about 7 wt %.

9. The composition of claim 1 further comprising TiO₂ present in an amount of about 0.1 to about 5 wt % TiO₂,

10. The composition of claim 1 further comprising TiO₂ present in an amount of about 0.1 to about 5 wt % and ZrO₂ present in an amount of about 2 to about 7 wt %.

11. The composition of claim 10 wherein the TiO₂ and ZrO₂ are present in a combined total weight percent of at least about 4 wt %.

12. The composition of claim 1 of the formula (Li₂, Zn)O.Al₂O₃.nSiO₂ where 8>n>2.

13. A method for preparing a negative-CTE composition comprising:
heating a glass with suitable nucleating agent to precipitate crystals of a glass-ceramic, the crystalline phase of the composition is a solid solution having a β-quartz structure of the formula nSiO₂—Al₂O₃—ZnO—Li₂O, where 8>n>2, and the composition being free of microcracks.

14. The method of claim 13 wherein the nucleating agent is at least one of ZrO₂, TiO₂, or combinations thereof, and heating the glass with suitable nucleating agent is accomplished: internally from the parent glass; externally nucleated from the surfaces of finely powdered glass; or a combination thereof.

15. The method of claim 13, wherein the heating is accomplished at about 750 to about 1,000° C. to provide a high degree of crystallization.

16. A method for preparing a negative-CTE composition comprising:
heat-treating a glass composition, on a weight percent oxide basis, comprising:
40 to 60 wt % SiO₂,
20 to 35 wt % Al₂O₃,
5 to 20 wt % ZnO,
1.5 to 5 wt % Li₂O; and
crystallizing the glass composition.

17. The method of claim 16, further comprising grinding the heat-treated composition into a powder prior to crystallizing.

18. A method for using a negative-CTE composition comprising:
combining a powdered glass-ceramic composition of claim 1 and a batch composition to reduce the CTE of the resulting articles or structural components prepared therefrom.

19. The method of claim 18, wherein the articles or structural components comprise a filler, a sintering aid, an artificial skin, a plugging material, or a combination thereof.

20. The method of claim 18, wherein the CTE of the resulting articles or structural components remains negative at 25° C. to 800° C.
